(19) United States
(12) Patent Application Publication
(10) Pub. No.: US 2010/0138372 A1
(43) Pub. Date: Jun. 3, 2010

(54) COGNITIVE PATTERN MATCHING SYSTEM WITH BUILT-IN CONFIDENCE MEASURE

(76) Inventor: Douglas A. PALMER, San Diego, CA (US)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/580,735

(22) Filed: Oct. 16, 2009

Related U.S. Application Data
(60) Provisional application No. 61/105,875, filed on Oct. 16, 2008.

(51) Int. Cl. G06N 3/08

(52) U.S. Cl. 706/25

(57) ABSTRACT

Artificial neural systems are very powerful tools for pattern matching, classification, feature extraction and signal analysis. Systems to date lack an essential feature of their biological counterparts, a measure of confidence that the network response has actually been trained and is not an artifact. In the proposed artificial neural system one output is a produced (trained) measure of confidence in the remaining outputs i.e. a measure of certainty that the inputs match the training data.

### CROSS-REFERENCE TO RELATED APPLICATIONS

The present application claims the benefit of U.S. Provisional Application No. 61/105,875, filed on Oct. 16, 2008, titled “Cognitive Pattern Matching System with Built-In Confidence Measure” (Atty. Dkt. No. 2260.0190000), which is incorporated herein by reference in its entirety.

### BACKGROUND OF THE INVENTION

1. Field of the Invention

The field of this invention is in the area of artificial neural systems or computational neurobiology. These systems are usually neuro-biologically inspired software models of cognitive processes that occur in the brain and vary from simple filters and pattern classifiers to more complex robotic control systems.

2. Background Art

Current neural models generally lack a key feature of the human brain—the ability to know what it doesn't know. This may be phrased another way—by saying we are confident when we know something well and not confident when we do not know a correct response. An example of this in action is to ask yourself if you know a fellow by the name of “Godwin Bolodanda.” For most people there is an instantaneous result: “I have never heard of this guy.” The human mind is very well developed at knowing what it doesn't know and police interrogators use this feature to great advantage in questioning suspects. If we ask another question, such as “Who was the first President?” likely the answer would be expressed with great confidence.

This peculiar quantity called “confidence” is key to many human activities from investing to driving to sports. If we are alone in an unfamiliar dark place and hear a strange noise we lose confidence and start to question every action. Detective novelists would say the “hackles on the back of his neck stood up” or he was frozen into immobility as a “fight or flight” instinct waited to manifest itself. We express that a corporate decision maker wavers as others anticipate a response. Why? Lack of confidence. A shopper hesitates before reaching for product ‘A’ or product ‘B’. A driver slows down when approaching a blind intersection. In these brief examples we can see that “confidence” is an important part of human behavior and is probably a strong element of survival.

The current generation of artificial neural systems (ANS), while much simpler than a human brain, are, nevertheless, trained to respond in certain ways to input stimuli model of operation. In general, the simpler systems appear as mathematical filters that could be referred to as pattern classifiers or pattern matching devices. In this mode they match the input “phase space” to an output response space i.e. sensor/effector operation. For example, optical character recognition, spectral matching, sound recognition, speech recognition, target recognition etc. One of the chief drawbacks of current systems is the behavior of the artificial cognitive system when it is exposed to data that was previously unseen. Typically, the result is unpredictable.

A good example of the unpredictable nature of the output from an artificial neural system is the behavior of a optical character recognition system. Let us assume that such a system looks at images of typewritten digits and attempts to classify them into the digits 0→9. This may occur in a feed-forward network that accepts a small image of 50 pixels square and with ten outputs. Depending on the pattern presented, one of the outputs of the network is trained to activate to a level of 1 and the others to remain at a zero level. We can train on many thousand samples. If we now present the network with a pattern that it has never seen before and which represents a character somewhere between a 3 and a 5 it invariably returns intermediate values on many of the outputs. This makes the output difficult to interpret. In some cases users select the largest output as a measure of confidence.

Another example is a neural network trained to perform a chemical spectral decomposition. In this case a continuous spectrum of chemical signatures, such as from a Gas Chromatograph, is analyzed for the presence of one or more chemical species. A neural network is trained from tested samples to interpret the spectrum and give relative abundances of several chemical components. If the analysis is performed with the intention of identifying the presence of explosives, biological hazards, or drugs then a positive result carries some actions. If the actions provoke an expensive response then a key aspect to the system is to prevent false-positives. This is difficult in the current context of neural systems because the behavior is unknown when exposed to data sets never seen before. Again, having the neural network produce a “confidence” for the resultant output would be beneficial, in fact, so beneficial that for drug or bomb detection producing a confidence is more important than identifying a particular substance.

### SUMMARY OF INVENTION

Embodiments of the invention include an artificial neural system comprising a set of neuron models, a set of interconnections between the neurons representing weights, a subset of the interconnections to serve as inputs, a subset of the interconnections to serve as outputs, a single output dedicated to producing a representation of the confidence in the other outputs, and a two-pass learning method.

In additional embodiments of the invention, the confidence output is trained to represent the accuracy of the association between the input(s) and the output(s) for the given data (training) set.

Further embodiments of the invention use a double pass through methodology. Embodiments of the invention additionally provide an associated confidence for each output. Embodiments of the invention further provide a novelty filter. Additional embodiments of the invention allow for plasticity.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present invention and, together with the description, further serve to explain the principles of the invention and to enable a person skilled in the relevant art to make and use the invention.

FIG. 1 shows an artificial neural system for solving artificial intelligence problems, in accordance with an embodiment of the present invention.

FIG. 2 shows a diagram illustrating a feed-forward confidence producing neural network, in accordance with an embodiment of the present invention.

FIG. 3 depicts an example computer system in which embodiments of the present invention may be implemented.

The present invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION OF THE INVENTION

### I. Introduction

The following detailed description of the present invention refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

It would be apparent to one of skill in the art that the present invention, as described below, can be implemented in many different embodiments of software, hardware, firmware, and/or the entities illustrated in the figures. Any actual software code with the specialized control of hardware to implement the present invention is not limiting of the present invention. Thus, the operational behavior of the present invention will be described with the understanding that modifications and variations of the embodiments are possible, given the level of detail presented herein.

### II. Artificial Neural Systems

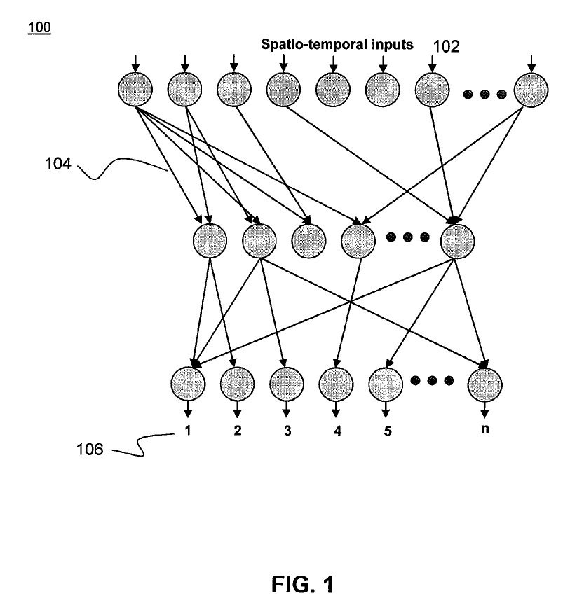

Embodiments of the invention relate to the use of artificial neural systems (ANS) for solving artificial intelligence problems without necessarily creating a model of a real biological system. Typically, in these systems, a set of spatio-temporal inputs is presented to a set of interconnected “neurons”; the neurons apply weights and other models to the inputs and pass the data on to other neurons or to outputs. This is illustrated in FIG. 1, which depicts a feed-forward neural network 100, in accordance with an embodiment of the present invention. The ANS varies the weights of the interconnections 104 to “learn” a pattern that is presented to it via spatio-temporal inputs 102, as in back-propagation, or through Hebbian learning which reinforces weights according to a cost function applied to the output 106. There are, generally, three main learning methods: reinforcement learning, supervised learning, and unsupervised learning.

Common systems used in this manner are Hopfield networks or three-layer Back-propagation networks operating in a supervised learning method that is an implementation of the Delta rule.

The gross result is that a “phase-space” of inputs is converted to a “phase-space” of outputs in an unprogrammed learning method i.e. there is no a priori knowledge of the properties or associations desired, only a particular result is desired. From this point of view an ANS is a system for pattern matching or clustering of inputs to selected outputs based upon training data but without rules-based logic related to the problem at hand. Examples of successful applications of neural networks include:
Optical character recognition
Speech recognition and speech synthesis
Machine and process control
Spectral decomposition and matching
Data compression
Function approximation
Time-series analysis and prediction

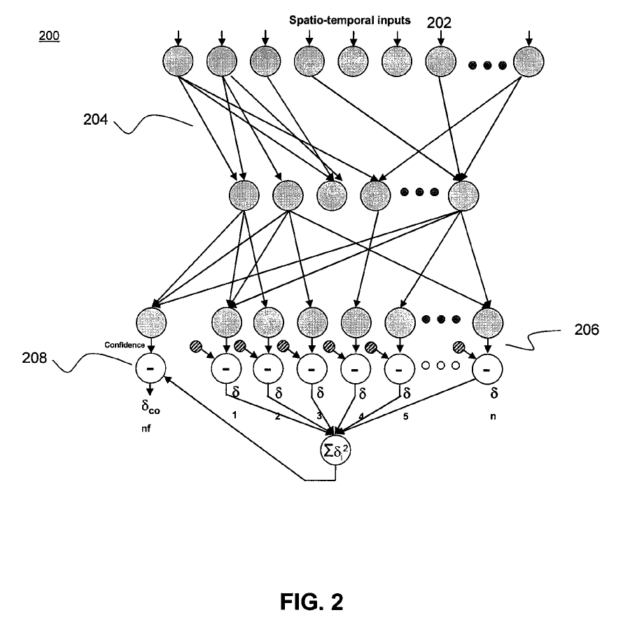

The invention provides a novel means for producing an artificial neural simulation that produces a trained output along with a confidence for the certainty of the output. This is accomplished through a unique means as diagrammed in feed-forward confidence producing neural network 200 of FIG. 2, in accordance with an embodiment of the present invention. An additional output to the network is added called the “confidence” 208. This output scales 0.0→1.0 and indicates the degree of confidence in the output from the network. As the network is trained, from the training set, it is trained to yield a value on this output indicative of the degree of lack of confidence (0.0) or full confidence (1.0) in the mapping from the spatio-temporal inputs to the normal output lines.

A methodology for training this network as a novel double-pass system is disclosed. In one embodiment of the invention the training steps are as follows:
1. Training (plasticity) is turned off.
2. The data (Iᵢ) is presented to the input layer.
3. The network propagates the information as activations through the network to the output layer (Oⱼ). The outputs are normalized from 0.0 to 1.0 (sigmoid).
4. The expected (teaching) results (Tⱼ) are subtracted from the outputs (Oⱼ) to yield a difference (δⱼ).
5. The sum of the squares of the differences is taken and subtracted from 1 to yield a global measure of accuracy of output:

$$Conf = 1 - \frac{1}{M} {\sum }_{j} {δ}_{j}^{2} .$$

6. Repeat steps 1, 2, & 3.
7. Turn training (plasticity) on. Use the previous calculation of “Conf” along with the training data to invoke Hebbian learning, weight reinforcement, back-propagation of errors etc.

The result of the above training method is to “train” the network to learn its own capacity for error. This double-pass system of learning has been implemented in networks trained for speech recognition, signal recognition, pattern matching, spectral decomposition etc. and found to have an uncanny accuracy. In terms of the mapping from the input “phase-space” to the output phase space the confidence activation effectively maps all the areas of phase space which do not match another given output.

One of the advantages comes from the ability to assign a confidence to the mapped outputs. The confidence is a very useful qualification for inhibiting costly actions as a consequence of presenting an input pattern to the ANS. This same confidence can be used to regulate plasticity (ability to learn), activating a novelty signal, or invoking a request for clarification. For example, if the CANS is used as a numeric character recognition classifier for printed checks then a low confidence for a value of a check might send the check back to a human reader to verify the amount.

This two-pass system can be used to create a “novelty filter” for turning plasticity on and off or to send an alert that data has been presented that does not match any assigned output.

### III. Learning Adjustment Mechanisms

There are many applications to this system. Anywhere that the power and utility of an artificial neural system is used to implement a decision in which there are consequences for a “false-positive” result can utilize this system. Examples are:
Bomb or explosive detection
Automatic target recognition
Drug detection
Financial market prediction

Other embodiments and modifications of my invention will occur readily to those of ordinary skill in the art in view of these teachings.

### IV. Example Computer System Implementation

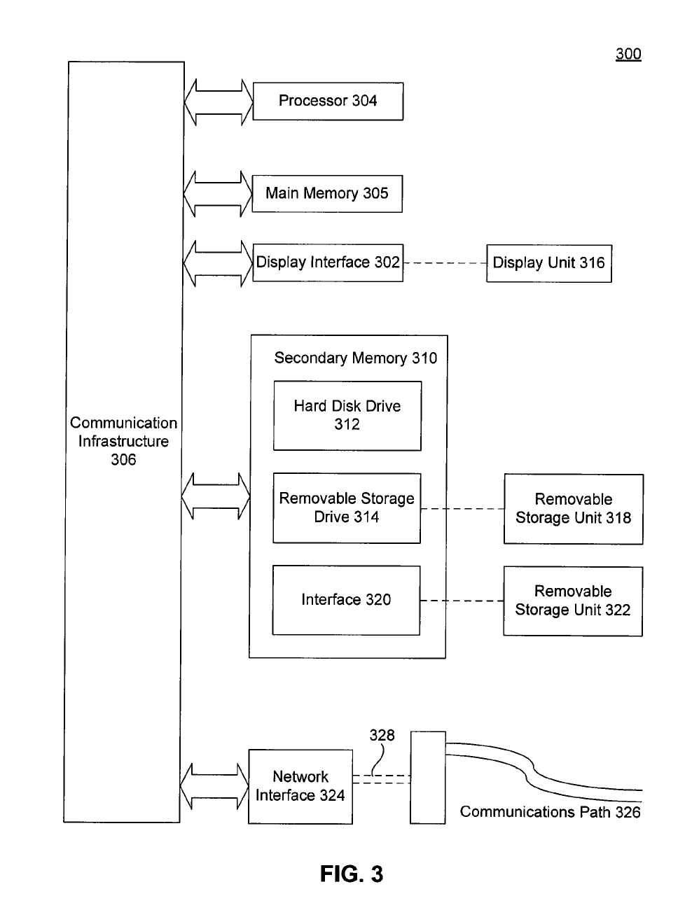

Various aspects of the present invention can be implemented by software, firmware, hardware, or a combination thereof. FIG. 3 illustrates an example computer system 300 in which the present invention, or portions thereof; can be implemented as computer-readable code. For example, the neural networks illustrated by FIGS. 1 and 2, can be implemented in system 300. Various embodiments of the invention are described in terms of this example computer system 300. After reading this description, it will become apparent to a person skilled in the relevant art how to implement the invention using other computer systems and/or computer architectures.

Computer system 300 includes one or more processors, such as processor 304. Processor 304 can be a special purpose or a general purpose processor. Processor 304 is connected to a communication infrastructure 306 (for example, a bus or network).

Computer system 300 also includes a main memory 305, preferably random access memory (RAM), and may also include a secondary memory 310. Secondary memory 310 may include, for example, a hard disk drive 312, a removable storage drive 314, and/or a memory stick. Removable storage drive 314 may comprise a floppy disk drive, a magnetic tape drive, an optical disk drive, a flash memory, or the like. The removable storage drive 314 reads from and/or writes to a removable storage unit 318 in a well known manner. Removable storage unit 318 may comprise a floppy disk, magnetic tape, optical disk, etc. which is read by and written to by removable storage drive 314. As will be appreciated by persons skilled in the relevant art(s), removable storage unit 318 includes a computer usable storage medium having stored therein computer software and/or data.

In alternative implementations, secondary memory 310 may include other similar means for allowing computer programs or other instructions to be loaded into computer system 300. Such means may include, for example, a removable storage unit 322 and an interface 320. Examples of such means may include a program cartridge and cartridge interface (such as that found in video game devices), a removable memory chip (such as an EPROM, or PROM) and associated socket, and other removable storage units 322 and interfaces 320 which allow software and data to be transferred from the removable storage unit 322 to computer system 300.

Computer system 300 may also include a communications interface 324. Communications interface 324 allows software and data to be transferred between computer system 300 and external devices. Communications interface 324 may include a modem, a network interface (such as an Ethernet card), a communications port, a PCMCIA slot and card, or the like. Software and data transferred via communications interface 324 are in the form of signals which may be electronic, electromagnetic, optical, or other signals capable of being received by communications interface 324. These signals are provided to communications interface 324 via a communications path 326. Communications path 326 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 318, removable storage unit 322, and a hard disk installed in hard disk drive 312. Signals carried over communications path 326 can also embody the logic described herein. Computer program medium and computer usable medium can also refer to memories, such as main memory 305 and secondary memory 310, which can be memory semiconductors (e.g. DRAMs, etc.). These computer program products are means for providing software to computer system 300.

Computer programs (also called computer control logic) are stored in main memory 305 and/or secondary memory 310. Computer programs may also be received via communications interface 324. Such computer programs, when executed, enable computer system 300 to implement the present invention as discussed herein. In particular, the computer programs, when executed, enable processor 304 to implement the processes of the present invention, such as the steps in the neural networks illustrated by FIGS. 1 and 2, discussed above. Accordingly, such computer programs represent controllers of the computer system 300. Where the invention is implemented using software, the software may be stored in a computer program product and loaded into computer system 300 using removable storage drive 314, interface 320, hard drive 312 or communications interface 324.

The invention is also directed to computer program products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. It should be understood that the invention is not limited to these examples. The invention is applicable to any elements operating as described herein. Accordingly, the breadth and scope of the present invention should not be limited by any of the above-described exemplary embodiments, but should be defined only in accordance with the following claims and their equivalents.

What is claimed is:

1. An artificial neural system comprising:
a set of neuron models;
a set of interconnections between the neuron models representing weights, wherein an input subset of the interconnections serve as inputs and an output subset of the interconnections serve as outputs;
a confidence output dedicated to producing a representation of the confidence in the output subset; and
a processor configured to apply a two-pass learning method to the set of neuron models, the set of interconnections, the input and output subsets, and the confidence output.
